(19) United States
(12) Patent Application Publication
(10) Pub. No.: US 2005/0172398 A1
(43) Pub. Date: Aug. 11, 2005

(54) Feedback control system to reduce the risk of pressure sores

(75) Inventors: Toby E. Smith, Broken Arrow, OK (US); Craig L. Cooper, Inola, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: BED-CHECK CORPORATION

(21) Appl. No.: 11/056,651

(22) Filed: Feb. 11, 2005

Related U.S. Application Data
(60) Provisional application No. 60/543,718, filed on Feb. 11, 2004.

(51) Int. Cl. A61G 7/08

(52) U.S. Cl. 5/81.1 R; 340/573.1; 5/616

(57) ABSTRACT

There is provided herein a support surface such as a bed or chair which contains a network of inelastic straps, the tension in each of which can be independently sensed and adjusted under control of an electronic monitor. Preferably, each strap will contain a plurality of sensors to allow an attached electronic monitor (preferably one with a microprocessor) to determine in real time the amount of pressure (or the duration of the pressure) applied to each strap. Based on that information, the attached monitor will periodically loosen or tighten the straps as needed to move support for the patient's body away from current pressure points. In one preferred arrangement, each strap will preferably be loosened or tightened through the use of a worm gear drive or similar mechanical motor.

### RELATED APPLICATION

This application claims the benefit of U.S. Provisional Patent Application Ser. No. 60/543,718 filed on Feb. 11, 2004.

### FIELD OF THE INVENTION

This invention relates generally to monitoring systems and more particularly concerns devices and systems used to monitor seated or lying patients in homes or in medical environments such as hospitals, institutions, and other care-giving environments so as to reduce the risk that such patients will develop pressure sores or decubitus ulcers.

### BACKGROUND OF THE INVENTION

It is well known that patients who are confined to a bed or chair for extended periods of time are at risk of developing pressure sores, i.e., decubitus ulcers, or bed sores as they are more commonly known. These ulcers are often seen to develop within soft tissue that is compressed between a bed or chair surface and a patient's weight-bearing bony prominences, the compressed tissue being at least partially of deprived of oxygenated blood flow. A continued lack of blood flow, and resultant lack of oxygen, can result in cell death, which may be evidenced in the form of pressure sores. Pressure sores do not develop immediately, but rather form over time, with the development speed depending on a number of factors including the firmness and friction of the supporting surface against the patient's skin, the patient/ambient temperature, the amount of moisture in contact with the skin, and the health and susceptibility of the skin due to age, illness, and/or nutrition.

One venerable and generally accepted means of reducing the risk of pressure sore development in bedfast patients is to turn them regularly, usually at approximately two hour intervals. For example, a patient in a back rest position might be periodically rolled to one side or the other, such motion helping to maintain blood flow to soft tissue that is under compression. Similar strategies are employed for patients that are confined to a chair for long periods of time. Obviously, an assisted-movement strategy relies largely on the vigilance of the (often harried) attending staff to insure that the patient is properly relocated. Further, it is far too easy for the busy caregiver to let the time for turning the patient slip by in the press of other daily emergencies. To the extent that the caregiver is too busy or forgets to perform this service, this method can fail to achieve its purpose. Further, this sort of strategy can be counterproductive for use with the patient that has some capacity for self-movement when, for example, the patient may have turned himself just before the caregiver arrived to manually turn him, in which case the caregiver will likely place the patient back in the position from which he recently moved, thus inadvertently exacerbating the problem. Further, after being rolled to a new position the patient might return to the original “comfortable” position after the caregiver leaves which would obviously negate the effects of the reposition.

The process of moving a patient to another position is admittedly disruptive to the patient and this is especially true at night, since the patient—if he or she were sleeping—will be awakened for the purpose of relocation. This typical two-hour movement interval must be observed around the clock if the method is to be effective, so it is necessary to disturb the patient—who might be sleeping soundly at the time—to make the required adjustment in position. Further, this adjustment might not have even been necessary, or might even be counter indicated, if the patient had recently moved of his or her own volition.

Thus, in many situations it would be advantageous for the caregiver to know if and when the patient last moved his or herself. Then, if the last movement were within a prescribed period of time, it might be possible to spare the patient an unnecessary interruption in his or her healing sleep. The caregiver would then relocate the sleeping patient, only if that relocation were actually required. Further, knowing which patients do not need to be moved could result in a substantial savings in labor costs, as the time that would otherwise be devoted to moving the patient that did not actually need to be moved could be productively applied elsewhere. That being said, as useful as this sort of information might be to the health care provider, however, the present state-of-the-art in patient management does not provide this sort information.

Generally speaking, there are two broad approaches to dealing with pressure sores: mechanical and medicinal. The medical approach is concerned with the development of medicinal compounds and methods for treating the ulcer after it occurs. This approach is obviously quite useful but ultimately it is reactive, rather than proactive, because it attempts to minimize the damage occasioned by the ulcer after it has formed.

On the other hand, the mechanical approach typically utilizes a specialized mattress, pad, or other arrangement, which is designed to lessen the interface-pressure that is brought to bear on the patient's bony prominences. These devices might be either static (e.g., foam, air, glass bead forced-air, or water mattresses) or dynamic (e.g., compartmentally inflatable mattresses that dynamically shift the locus of support pressure under the patient over time. Examples of inventions in the prior art that are generally concerned with this subject matter include U.S. Pat. Nos. 4,425,676, 5,926,884, and 5,072,468, the disclosures of which are incorporated herein by reference. Generally speaking, a mechanical approach is to be preferred because it seeks to spare the patient the discomfort and risk associated with bed sores and reduces the costs associated with treating such, which costs can potentially accrue to the facility under some circumstances.

One enhanced variant of the mechanical approach utilizes a proactive strategy that seeks to avoid tissue death by using a combination of automatic monitoring of the patient's movement together with notification of a caregiver if the patient's movement pattern does not meet or exceed some predetermined level. Upon receipt of such notice, the caregiver will then manually turn the patient, as has been the custom heretofore. This approach, if properly implemented, has the potential to dramatically reduce the risk of pressure sores while keeping the cost of such preventative measures within the reach of small institutions and individual patients.

However, as effective as this approach may be, in some settings a more proactive approach may be necessary. In more particular, Adams (U.S. Pat. No. 6,536,791, the disclosure of which is incorporated herein by reference) teaches a wheelchair seat which is formed of a matrix of spaced apart inelastic straps, wherein each strap is manually adjustable in length to increase or decrease the amount of tension thereon. The advantage of such an arrangement is that the patient's weight-bearing pressure points may be relieved by manually loosening the straps that are underneath the current “hot spots” and tightening other straps, thereby shifting the weight-bearing areas of the body to the newly-tightened straps. However, the Adams invention can be difficult to use in practice because it relies on direct intervention by the caregiver. Further, since this adjustment should ideally be done every hour or so, long term use of this sort of invention could prove to be impractical. Note that the term “hot spot” will be used herein to mean a high interfacial pressure point or other point on the patient's body that in danger of becoming necrotic due to ischemia.

Finally, there are any number of mechanical methods that seek to reduce the risk that a patient will develop pressure sores. By way of example, there are beds that are in constant motion and which utilize electromechanical, hydraulic, or pneumatic means of relocating the patient so that he or she does not rest for too long a time in any position. However, one obvious disadvantage of such devices is that they move the patient whether or not he or she actually needs to be moved, i.e., whether or not the patient has moved recently under his or her own power. Further, since many of these devices are in near constant motion they can make it difficult for the patient to experience restful and healing sleep. This problem arises because these devices do not actively monitor the patient's movement history. Instead, they manually relocate a patient based on the dictates of an attached clock or timer. No consideration is given to whether a particular relocation of a patient could be eliminated in view of his or her recent movement history. The cost to the facility of these support surfaces is also high and the equipment is not easily moved to accommodate changing patient needs.

General information relating to mat-type sensors and electronic monitors for use in patient monitoring is relevant to the instant disclosure and may be found in U.S. Pat. Nos. 4,179,692, 4,295,133, 4,700,180, 5,600,108, 5,633,627, 5,640,145, 5,654,694, 6,111,509, and, 6,784,797 (the last of which concerns electronic monitors generally). Additional information may be found in U.S. Pat. Nos. 4,484,043, 4,565,910, 5,554,835, 5,623,760, 6,417,777 (sensor patents) and U.S. Pat. No. 5,065,727 (holsters for electronic monitors), the disclosures of all of which patents are all incorporated herein by reference. Further, U.S. Pat. No. 6,307,476 (discussing a sensing device which contains a validation circuit incorporated therein), U.S. Pat. Nos. 6,544,200, (for automatically configured electronic monitor alarm parameters), 6,696,653 (for a binary switch and a method of its manufacture), and U.S. patent Ser. No. 10/125,059 (for a lighted splash guard) are similarly incorporated herein by reference.

Additionally, sensors other than mat-type pressure sensing switches may be used in patient monitoring including, without limitation, temperature sensors, patient activity sensors, toilet seat sensors (see, e.g., U.S. Pat. No. 5,945,914), wetness sensors (e.g., U.S. Pat. No. 6,292,102), pressure sore sensors (e.g., U.S. Pat. No. 6,646,556), etc., all of which are incorporated herein by reference. Thus, in the text that follows the terms “mat” or “patient sensor” should be interpreted in its broadest sense to apply to any sort of patient monitoring switch or device, whether the sensor is pressure sensitive or not.

Finally, pending U.S. patent application Ser. No. 10/397,126, also incorporated herein by reference, discusses how white noise can be used in the context of pressure sore prevention.

Heretofore, as is well known in the patient monitoring and, more particularly, in the pressure sore prevention arts, there has been a need for an invention to address and solve the above-described problems. There has been for some time a need for a device which, depending on a patient's movement history, may manually relocate the patient or not. Accordingly, it should now be recognized, as was recognized by the present inventors, that there exists, and has existed for some time, a very real need for a system for monitoring patients that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of this invention within the ambit of the appended claims.

### SUMMARY OF THE INVENTION

In accordance with a first preferred aspect of the instant invention, there is provided a support surface such as a bed or chair which contains a network of inelastic belts or straps, the tension in each of which can be independently sensed and adjusted under control of an electronic monitor. In the preferred arrangement, each strap will contain a plurality of sensors therein to allow the attached monitor (preferably one that utilizes a microprocessor or a similar programmable/active device) to determine in real time the amount of pressure (or, in one preferred alternative, the duration of the pressure) created by the patient's weight on each of the supporting straps. Based on the information provided by the sensors, the attached monitor will periodically loosen or tighten the straps as needed to move support for the patient's body away from its then-current pressure points. In one preferred arrangement, each strap will be loosened or tightened through the use of a worm gear drive or similar mechanical motor. Preferably, the tension on each strap will be independently controllable.

In another preferred arrangement, the instant invention will be installed on a bed so that patients who are confined therein may be similarly benefited. In more particular, preferably an interwoven lattice of belts or straps will span the width of the bed, preferably in an “X” or crossing pattern. As was described previously, preferably the amount of pressure that is supported by each of the straps will be separately estimated and periodically various ones of the straps will be loosened or tightened to move support away from tissues that might be developing ischemia.

In another preferred embodiment, there is provided an active bed, e.g., a bed which is hinged twice along its lengthwise axis thereby dividing it roughly into thirds, which bed is designed to manually turn the patient only when required. That is, in the preferred arrangement the patient's movement within the bed will be monitored to see if he or she changes position under his or her own power. If not, the patient will be rolled from one side to another by manually flexing the bed hinges. It is important for purposes of the instant invention that the patient only be disturbed by rolling when necessary, i.e., only if he or she has not moved recently. The attached electronic monitoring device is intended to include A.I. (i.e., artificial intelligence) which will allow it to adapt to individual patient needs by, for example, remembering past control moves and using them to anticipate impending control needs.

According to still another preferred embodiment, there is provided a patient support device substantially as described above, but wherein a patient movement threshold is established such that only significant movements, i.e., movements to a new position that are maintained for a predetermined period of time, are sufficient to cause the device to reset and withhold mechanical adjustment of the patient's position.

According to a further preferred aspect of the instant invention, there is provided a support device substantially as described above, wherein a patient movement threshold is established as described previously, but wherein the significant movement must be maintained for some period of time. That is, if a patient moves to a new position, but then returns to nearly the original position within a short period of time (e.g., within ten minutes), the monitor timer will not be reset, and at the appropriate time the support surface will automatically adjust the patient's position thereon.

Finally, it should be noted that it is an object of the instant invention that, whatever mechanism is utilized, the control apparatus should be configured in the form of a feedback system that only moves the patient when it necessary to do so. In more particular, in the preferred embodiment the patient will be monitored to see if he or she has moved under his or her own power and, if so, no movement/intervention will take place. On the other hand, if the patient has not moved within the stipulated time period—and, preferably, only if the patient has not moved him or her self within the stipulated time period—the instant invention will automatically shift the patient's weight bearing points away from those that are currently under pressure, without specific input required from the end user.

The foregoing has outlined in broad terms the more important features of the invention disclosed herein so that the detailed description that follows may be more clearly understood, and so that the contribution of the instant inventor to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Further, the disclosure that follows is intended to apply to all alternatives, modifications and equivalents as may be included within the spirit and scope of the invention as defined by the appended claims. Finally, it should be understood that the phraseology and terminology employed herein are for the purpose of description and should not be regarded as limiting, unless the specification specifically so limits the invention.

While the instant invention will be described in connection with a preferred embodiment, it will be understood that it is not intended to limit the invention to that embodiment. On the contrary, it is intended to cover all alternatives, modifications and equivalents as may be included within the spirit and scope of the invention as defined by the appended claims.

### BRIEF DESCRIPTION OF THE DRAWINGS

Other objects and advantages of the invention will become apparent upon reading the following detailed description and upon reference to the drawings in which:

FIG. 1 illustrates a preferred wheelchair embodiment of the instant invention, wherein is provided a seat that is automatically adjustable to relieve pressure points in a patient seated therein.

FIG. 2 contains a more detailed top view of the seat of FIG. 1.

FIG. 3 contains a cross sectional image of a preferred embodiment of the instant feedback controlled support surface that illustrates how the strap that is located at the front of the chair is preferably supported.

FIG. 4 is a cross sectional image of a preferred embodiment of the instant invention which is taken in a direction parallel to that of FIG. 3.

FIG. 5 is a cross sectional image of a preferred embodiment of the instant invention which is taken in a direction orthogonal to that of the view in FIG. 3.

FIG. 6 is a diagram of a preferred embodiment which utilizes a plurality of sensors within each strap to measure the amount and/or duration of pressure thereon.

FIG. 7 contains a schematic illustration of some typical weight bearing regions in a patient that can become hot spots which then can develop further into pressure sores.

FIG. 8 illustrates a preferred embodiment wherein the support surface is a bed.

FIG. 9 contains a schematic illustration of a preferred optical sensor that would be suitable for use within a support strap.

FIG. 10 illustrates another preferred optical sensor that would be suitable for use within a support strap for use within a support strap.

FIG. 11 contains an illustration of another preferred optical sensor for use within a support strap.

FIG. 12 illustrates a preferred apparatus and arrangement for reading the status of the strap sensors.

FIG. 13 contains a preferred operating logic suitable for use with the instant invention.

FIG. 14 illustrates an active bed device suitable for use with the instant invention.

FIG. 15 illustrates a sensor suitable for use with the instant invention that would allow patient position and weight bearing on each switch to be separately determined.

FIG. 16 illustrates the use of a prior art turn sheet to roll a patient to a new position with a bed.

FIG. 17 contains an illustration of a preferred automatic method for mechanically moving a patient to a new position in a bed through the use of hydraulic lifters.

FIG. 18 illustrates another preferred embodiment wherein inflatable bladders are used in a chair or bed to move the patient to a new position under computer control.

FIG. 19 contains an illustration of a preferred chair or bed embodiment for reducing the risk of pressure sores, wherein the support surface is comprised of multiple/individually movable elements, each of which can be raised or lowered under software control.

### DETAILED DESCRIPTION OF THE INVENTION

In accordance with a first preferred aspect of the instant invention, there is provided a support surface such as a bed or chair which supports the patient with a plurality of relatively inelastic straps preferably arranged in a lattice configuration. Preferably, the tension in each of the support straps can be independently sensed and adjusted. Further, and preferably, each support strap will contain a plurality of sensors therein to allow an attached electronic monitor (preferably a monitor that contains a microprocessor or similar programmable device) to determine in real time the amount of pressure or tension (or the duration of the pressure or tension) applied to each strap. Based on that information, the attached monitor will periodically cause an attached worm gear motor or similar device to increase or increase the tension in each strap by lengthening or shortening selected ones thereof. Preferably, the tension on each strap will be independently readable and controllable.

### PREFERRED EMBODIMENTS

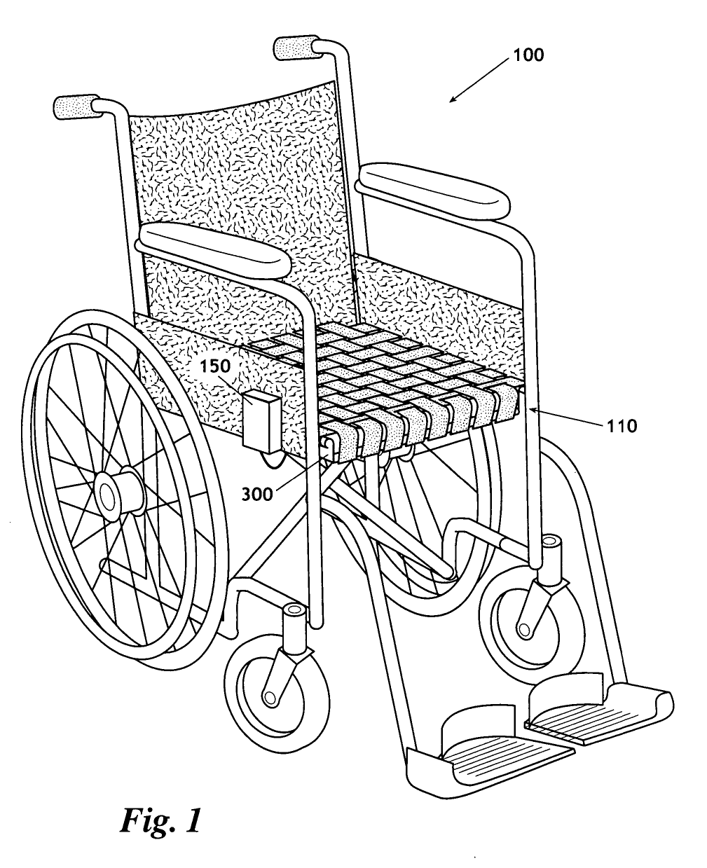

FIG. 1 illustrates a preferred embodiment of the instant invention wherein an adaptive support surface 110 is installed within a wheelchair 100. Additionally, an electronic patient monitor 150 is preferably placed in electronic communication with the support surface 110 and, as is described in greater detail below, controls its operations when the patient is present thereon.

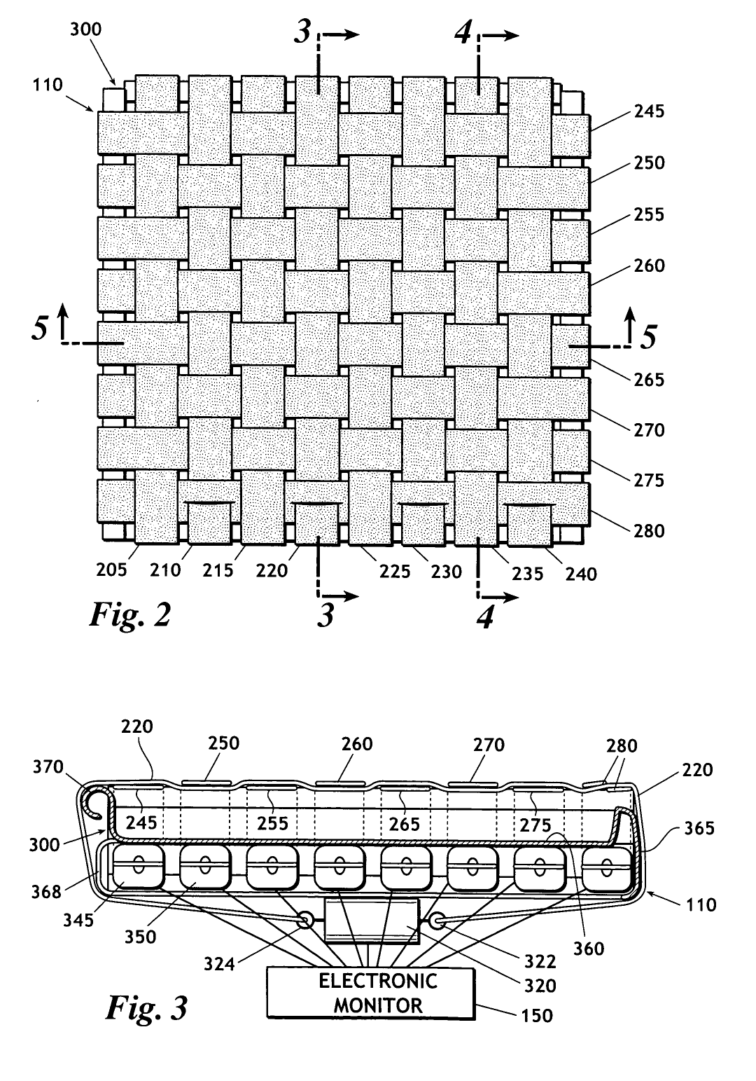

As can be best seen in FIGS. 3, 4, and 5, support surface 110 preferably has at its core a generally rectangular rigid member 300. Although many materials might be suitable for use in constructing the member 300, because of the stress that is applied to the device it is preferred that it be constructed of a material such as metal (e.g., stainless steel or aluminum) or some other sort of reinforced material such as plastic. FIG. 2 illustrates the support member 110 in greater detail. As can be seen, it preferably utilizes on its upper surface a lattice work of interleaved straps 205-280. Preferably, each of these straps will be relatively inelastic or, more preferably, substantially inelastic, for reasons to be discussed hereinafter. Note that the straps are tightly wound around frame 300, which is preferably a rigid construct with sufficient strength to withstand the forces created by tightening the multiple straps 205-280.

Note that the strap 280 in the preferred embodiment of FIGS. 3-5 contains plurality of longitudinal splits therein through which straps 210, 220, 230, and 240 are threaded. By way of explanation, in the preferred arrangement, the frame member 300 will not have a weight bearing cross member at the front thereof. One reason for this is to reduce the possibility that the patient will be injured by having an unyielding surface at the very front of the chair. Of course, those of ordinary skill in the art will recognize that putting an unyielding cross member beneath the patient's legs could put the patient at risk of pressure sores at that point because at least the weight of the patient's legs would tend to hang from—and be supported by—the cross structural member. As a consequence, the instant invention preferably eliminates this cross member and instead utilizes the front strap 280 as a support member. That is, longitudinal slits in strap 280 provide a mechanism by which straps 210, 220, 230, and 240 may be supported. Clearly, straps 205, 215, 225, and 235 are already supported as they pass on top of strap 280. In this manner, a rigid frame member can be eliminated from the front of the support surface 110. That being said, the invention would work similarly if such a cross member were in place.

FIGS. 3, 4, and 5 illustrate in greater detail the preferred embodiment of the instant frame member 300. As can best be seen in FIG. 3, preferably the frame member 300 has an upwardly disposed vertical lip 370 which is preferably rounded on its upper terminus to facilitate the movement back and forth of the straps 205-240. That is, and as will be explained in greater detail below, in the preferred arrangement the straps will be loosened and tightened in order to relieve pressure points on the patient's body and shift support of the patient's weight to another location. As a consequence, it is preferred that a round or smoothly curved structure be provided so that the straps will not be abraded by the necessary tightening and loosening.

Preferably, the frame member 300 will contain integral thereto a pan 360 or similar structure for containing fluids, which pan should be impervious to the passage of fluids therethrough. Although this feature is not an essential element of the instant invention, it is still highly desirable. Those of ordinary skill in the art will recognize that it is not uncommon for patients who are confined to wheelchairs to have occasional incontinence problems. The proposed pan structure 360, in addition to reducing the amount of cleanup that would be necessary in the event of such an accident, will also serve to protect the delicate mechanical and electrical components that are preferably used to automate the adjustment of the straps 205-280. As can also be seen in FIG. 3, preferably the frame member 300 will contain downwardly extending underside lips 365 and 368 around which straps 205-240 will be tightened.

That being said, those of ordinary skill in the art will recognize that, although the use of a pan that is integral to frame member 300 is the preferred variation, it is certainly possible that a simple skeletal frame that defines the periphery of the frame member 300 could be used instead. For example, the periphery could be formed from four sections of stainless steel or some other tubing that have been joined together to form a rectangle with a void in the center thereof. Of course, in such an embodiment one or more stiffening cross members might be added in view of the tension that will necessarily be applied to the straps in practice.

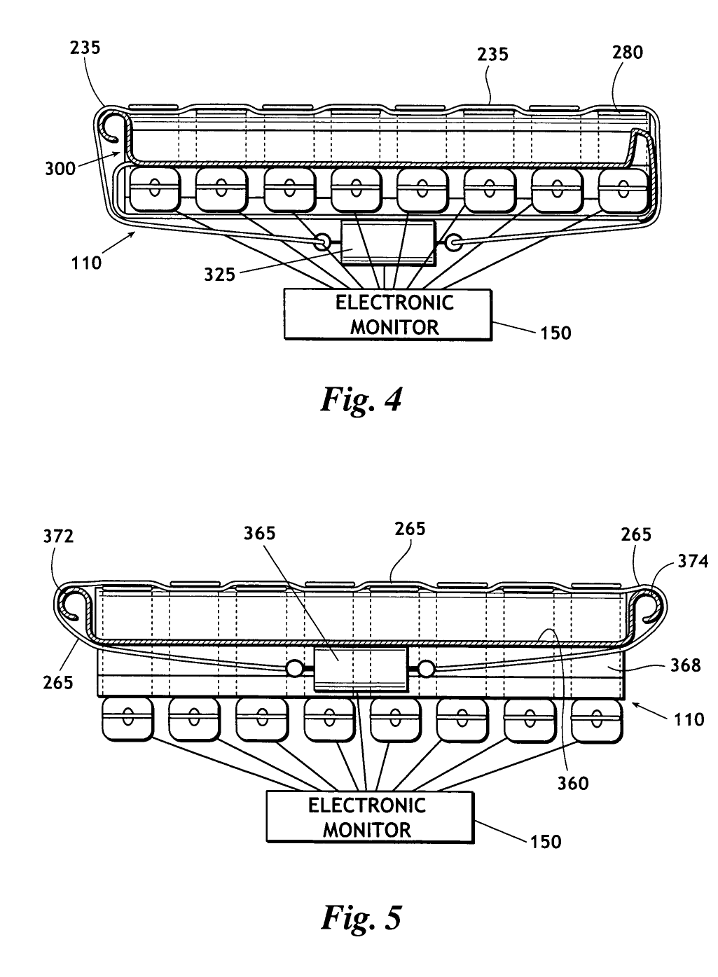

FIG. 4 is a cross section of the instant support surface 110 which is taken parallel to the cross section of FIG. 3 and which is taken through the center of strap 235. This figure illustrates once again that an unyielding support member 365 is not necessary at the front of frame member 300, as strap 280 is designed to serve in that capacity.

FIG. 5 is a cross section of the support surface 300 taken through the center of strap 265 in the direction orthogonal to the cross sections of the previous two figures. As can be seen, it is preferred that there be upward extending lips 372 and 374 on each side of the support surface 110. The purpose of these lips 372 and 374 is, of course, to provide vertical support to the straps that traverse the support surface 110 in a left to right (with respect to FIG. 2) direction. As has been discussed previously, the vertically extending walls 372 and 374 will preferably have a rounded upper surface to facilitate the movement of the straps to and fro thereon (e.g., the upper surface might be coated with a friction reduction material such as Teflon, chrome, etc.). Also, preferably these walls 372 and 374 will form some part of the upward extent of the pan 360 to assist in the containment of fluids.

Turning again to FIG. 3, in a preferred embodiment a plurality of tensioners (e.g., electrical motors or pneumatic cylinders, etc.) will be provided for the tightening and loosening of the straps 205-280. As is indicated in this figure, tensioner 320, which is preferably a worm gear drive or similar electrical motor, is positioned so that the two ends of strap 220 can be engaged with its connectors 322 and 324, respectively. Those of ordinary skill in the art will recognize that when tensioner 320 is activated, one or both of the connectors 322 and 324 will either be drawn into the housing of the tensioner 320 or extend further from it depending on the direction of the movement within the tensioner 320. Of course, by extending the connectors 322 and 324 further away from the center of the tensioner 320, the tension in strap 220 will be lessened and it will tend to sag downward. Alternatively, if the tensioner 320 is operated to draw connectors 322 and 324 back into its housing, that will tend to tighten the strap 220 against vertical partition 370 and strap 280, thereby raising it upward and causing it to support more of the patient's weight. Similarly, relaxing the tension in a strap (e.g., by extending one or both of the connectors 322 and 324 in an outward direction away from the tensioner 320) will tend to shift the patient's weight to other straps. Preferably, each strap 245-280 will have its own tensioner associated therewith. As will be discussed later, such an arrangement makes it possible to selectively tighten or loosen each of the straps in the grid as needed.

FIG. 5 contains a cross section taken in a direction perpendicular to that of FIG. 3 and it illustrates in better detail how the instant invention utilizes a stacked configuration of tensioners to accomplish its task of adjusting tension in the entire array of straps. Note that the motors for belts 245-280 are designed to lie above the tensioners for straps 205-240. Although this is the preferred arrangement, those of ordinary skill in the art will be able to design many alternatives. As can be seen straps 245-280 are supported against the upwardly projecting walls 372 and 374 and the lower corner of pan 360. On the other hand, the tensioners for straps 205-240 lie in a plane that is below that of the tensioners for straps 245-280. As can best be seen by reference to FIGS. 3 and 4, straps 205-240 are supported by upwardly extending partition 370 on one end and strap 280 on the other end and, on the under side of the support surface 110, by downwardly extending lips 365 and 368. This arrangement allows as many tensioners as there are straps to be included as part of the support surface 110. Note that, in the preferred arrangement, a total of eight straps in each direction would normally be employed which means that a total of 16 tensioners would need to be mounted underneath the support surface 110 as has been illustrated in FIGS. 3-5.

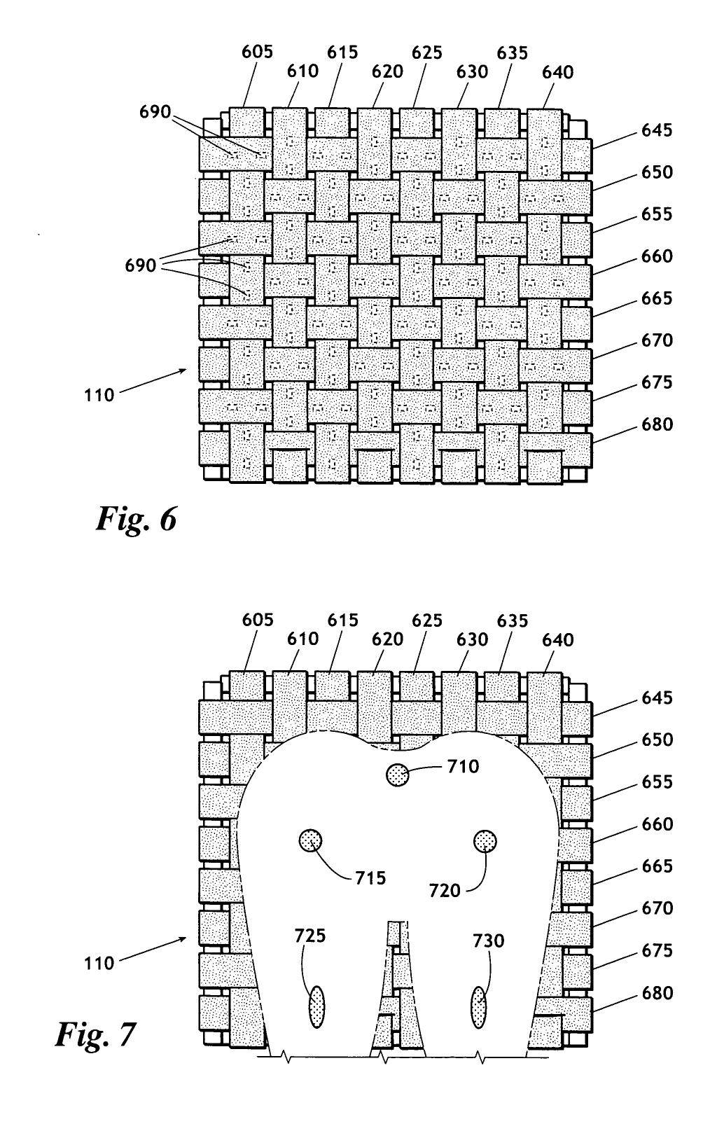

FIG. 6 illustrates one preferred sensor arrangement for use with the instant support surface 110. That is, preferably a plurality of sensors 690 will be provided within each strap 605-680 so that the patient's position on the surface may be determined by a separate electronic patient monitor 150. In a preferred arrangement, each of these sensors will be separately read by the patient monitor 150 thereby making it possible to determine precisely where the patient's weight is resting at any point in time. That being said, those of ordinary skill in the art will recognize that, if the tension on the belts 605-680 were continuously redetermined, in some applications the sensors 690 could be eliminated, as measurements of the actual tension on each belt could be utilized by an attached monitor to estimate where the patient's weight was resting. That being said, in the preferred arrangement, separate sensors 690 will be used.

As is suggested in FIG. 6, preferably the sensors 690 will be incorporated into the straps 605-680. In one preferred arrangement, at least the portion of each strap that is on top of support device 110 will consist of two layers. Preferably, each such layer will be nonconductive and impervious to fluids. The two layers will preferably be sealed together along their edges and at least at the terminus where the ends are joined to the connectors of one of the tensioners 305-380. Preferably, the sensors 690 of the sort discussed hereinafter will be placed in the space between the two members that comprise each strap.

In one preferred arrangement, the sensor 690 will be a simple on/off or open/closed pressured-actuated switch. That is, each switch 690 will be open or closed depending on whether or not the patient has rested sufficient weight on that particular sensor to force it closed. The attached electronic patient monitor might use this information (i.e., whether each of these switches 609 is opened or closed) in many ways. However, two preferred ways are as follows. First, it is possible to obtain a qualitative assessment of the pressure on each strap by noting the number of switches 690 which are opened or closed in a particular strap. When that information is taken in combination with a count of the switches that are opened or closed in a transverse direction, an overall pattern of the weight bearing points of the patient's anatomy may be constructed. For example, and as generally illustrated in FIG. 7, a seated patient will tend to have hot spots or pressure points at locations 715-730. Those of ordinary skill in the art will recognize that 710 corresponds to a patient's sacrum/coccyx, locations 715 and 720 to the ischial tuberosities (i.e., the downwardly projecting portions of the pelvic bone), and locations 725 and 730 to the underside of the patient's legs at the femur. In this typical configuration, those sensors 690 near the intersections of strap 620 and strap 650 would tend to be closed. An attached electronic monitor could be programmed to sense the pattern of switch closures in this vicinity and should be able to recognize it as a potential weight bearing point. Of course, sensitivity of the switches 690 might need to be adjusted depending on the weight of the patient. Similarly, switches/sensors 690 in the vicinity of the intersection of straps 615 and 650 would tend to be closed beneath weight bearing point 715, etc. Given knowledge of the patient's weight bearing locations, that information can be used to modify the patient's weight distribution according to the methods discussed hereinafter.

Additionally, it is contemplated that not only the pattern of on/off switches would be used but, additionally, the length of time each sensor 690 has been closed. Those of ordinary skill in the art will recognize that the fact that a part of the body is weight bearing is not, standing alone, of primary concern. Rather, concerns are raised when the weight is sufficient to cut off the flow of oxygen to tissues at that location and that weight is born for a period of time sufficient to cause oxygen starvation (ischemia) of the supporting tissues. Of course, this condition will eventually cause necroses and the development of pressure sores at the support point.

As a consequence, it is preferred that the attached patient monitor track the particular switches that are closed as well as the length of time that each switch has been closed. This will preferably have two main consequences. First, if the patient is exhibiting sufficient movement on a support surface 110, it may not be necessary to adjust the tension in the support straps at all. And, second, this information would allow an attached patient monitor to notify a caregiver in the event that the adjustment discussed hereinafter proved to be ineffective and the patient appeared to be at risk of developing pressure sores. It should be noted that the previous comments would apply to any sort of sensor 690 whether that sensor were binary or of a more continuous/multi-valued nature.

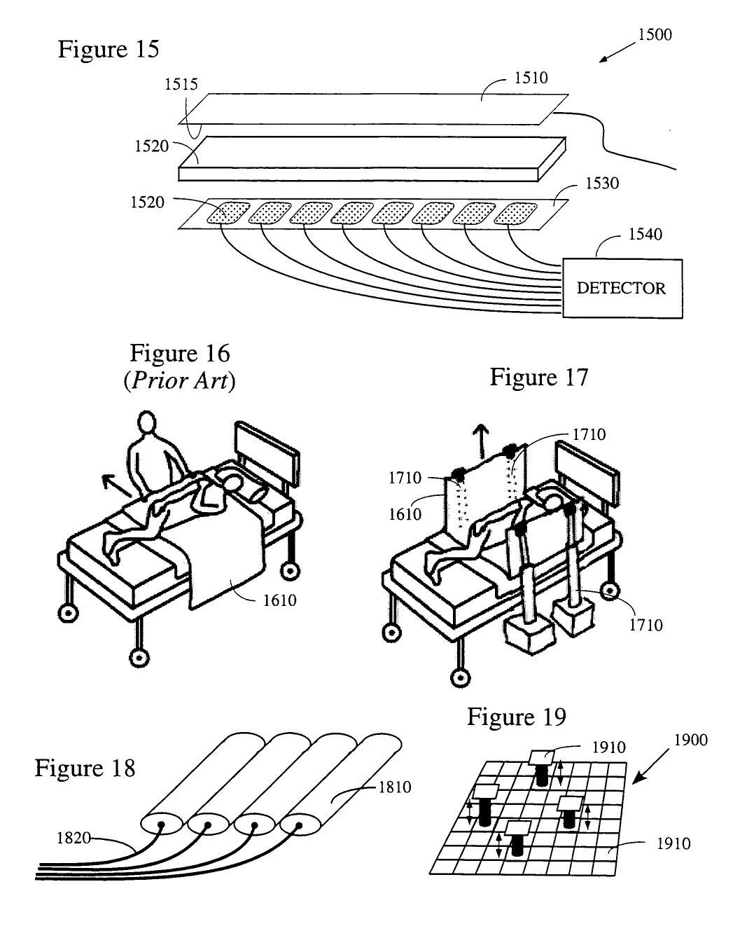

Of course, sensors 690 could certainly be more sophisticated than simply on/off switches. To the extent that sensors 690 can directly measure pressure or tension in the supporting straps, such information would provide other ways to help predict or avert the development of pressure sores. Given sensors that provide more than on/off readings, it would be possible to quantify the amount of pressure resting on each support point of a patient's body. FIG. 15 illustrates a specific example of such a sensor 1500. In the preferred embodiment, a capacitance-based sensor will be constructed by utilizing a compressible dielectric material (e.g., foamed Teflon) that has been is placed between two electrically conductive plate-like elements. By noting that the capacitance of such an arrangement varies inversely as a function of the distance between the conductive members, and further knowing the compressibility of the dielectric material, it is possible use such information to determine—not only the location of the patient on the sensor 1500—but also the amount of weight resting on each sensor.

By way of a more detailed explanation, upper member 1510 will be electrically conductive at least on its lower surface 1515. In one preferred embodiment, the upper member 1510 will be made of polyester or a similar material that is impervious to fluids. At least a portion of its lower surface 1515 is preferably coated with an electrically conductive film such as aluminum and is placed in electrical communication with ground. One advantage of this arrangement is that having the ground on top will tend to limit the effect of the patient's body on the measured capacitance value. Lower member 1530 has a plurality of conductive regions 1520 thereon which are maintained in electrical communication with a detector 1540. Detector 1540 is preferably a chip with features similar to those of the Motorola chip MC33794E.

In practice, the detector 1540 would determine the capacitance as measured by each of the conductive regions 1520. One preferred method of doing this would be to separately determine the oscillation frequency at each point along the capacitive sensor 1500. Such frequency will, of course, be related to the capacitance of the separate capacitors formed by conductive regions 1520/dielectric material 1520/upper conductive region 1515. Since the capacitance at each point of such a sensor 1500 will vary with the distance between upper member 1510 and lower member 1530, a determination of the distance between the members will allow for a determination of where the patient's weight is resting on the sensor 1500. However, if the compressibility of the dielectric material 1520 is taken into consideration, an estimate may also be obtained of the weight that is resting on the sensor 1500 at each point 1520. The importance of this measurement to the formation of pressure sores should be clear.

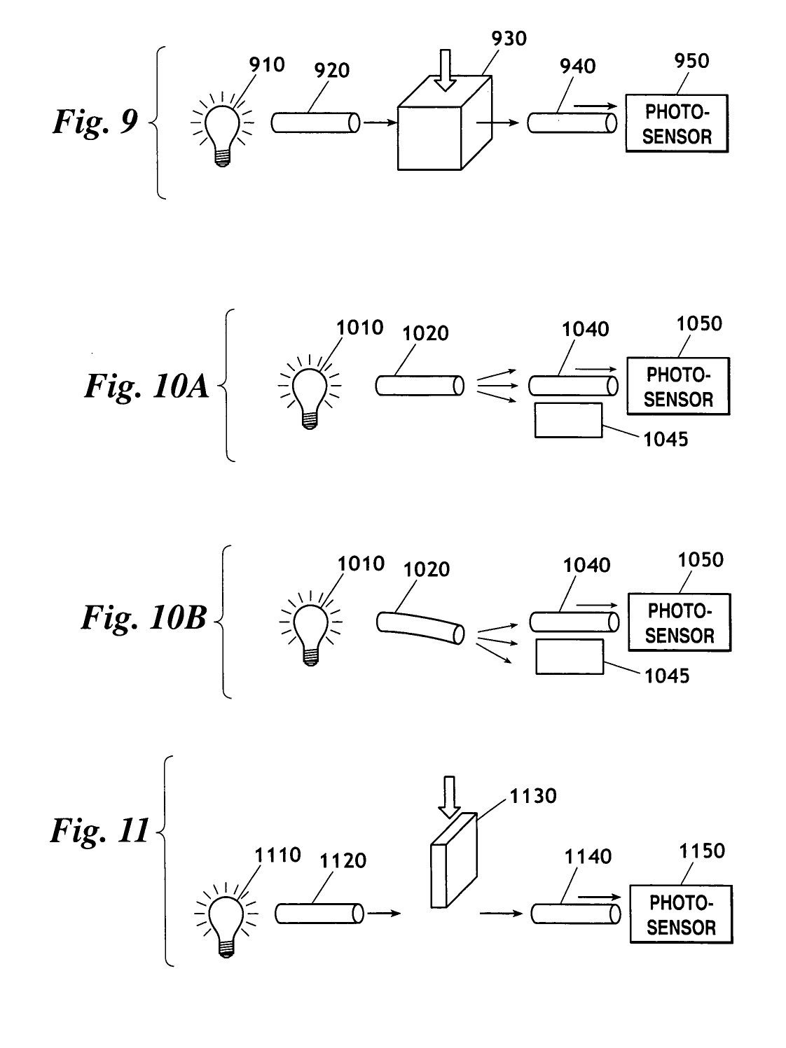

FIGS. 9-11 illustrate some examples of optical switches that would be suitable for use as sensors 690. In FIG. 9, a light source 910 directs light into light conduit 920 (e.g., a fiber optic line) which delivers that light to compressible foam block 930. As is well known to those of ordinary skill in the art, some varieties of open cell foam exhibit a change in optical transmissivity when they are placed under compression. That is, the amount of light that is transmitted through foam block 930 varies as a function of its degree of compression, with greater compression tending to attenuate the light passing therethrough more (i.e., greater compression reduces the block's transmissivity). In the preferred arrangement, optical conduit 940 receives light that has passed optical attenuator 930 and transmits it further to photo sensor 950 where the amount of light transmitted through the system may be quantified. Those of ordinary skill in the art should recognize that this switch could be used as a simple on/off switch (i.e., measuring whether or not the patient rests a threshold amount of on this particular switch) or, as a semi-continuous measure of the amount of the patient's weight that rests on this particular sensor. In the later case, a correlation would need to be established between the degree of compression of the foam block 930 and the amount of light that would be transmitted therethrough.

FIGS. 10A and 10B illustrate another preferred sensor embodiment, wherein light is used once again to indicate whether or not a patient's weight is resting on this particular switch. As is indicated in these figures, if there is no weight resting on the switch (i.e., FIG. 10A), light source 1010 transmits light into light conduit 1020 which then radiates light into pickup conduit 1040, the terminus of which is located proximate to terminus of the source conduit 1020. The light passing through pickup conduit 1040 is then read and quantified by photo sensor 1050. As should be clear, so long as there is no weight on this particular switch, light is maximally transmitted from conduit 1020 to light conduit 1040. However, if downward pressure is applied to this switch, the termini of the delivery conduit 1020 and the pickup conduit 1040 are forced into misalignment, thereby reducing the quantity of light that is received at photo sensor 1050. Preferably, a support body 1045 will be provided beneath conduit 1040 so that when the sensor is compressed, differential compaction occurs and the unsupported fiber 1020 tends to move downward to a greater extent than the pickup conduit 1040. Preferably, support body 1045 will be a relatively stiff foam block or a similar compressible substance. Thus, by measuring the intensity of the received light, it will be possible to determine whether or not any significant weight from the patient is resting on a particular sensor. Note that, by varying the stiffness in the straps 605-680 (e.g., selecting less flexible materials for the straps, adding backing to the strap, etc.), it will be possible to calibrate the switch of FIG. 10 to only show a significant response when a predetermined amount of weight were present thereon.

Finally, FIG. 11 illustrates another preferred sensor 690 embodiment, wherein light is received or not at photo sensor 1150 depending on whether shutter 1130 has been forced downward between the source 1120 and receipt 1140 optical conduits. That is, in this preferred sensor embodiment, light source 1110 provides that light that is transmitted by source conduit 1120 to a location that is proximate to the input terminus of pickup optical line 1140. If the patient is not resting significant weight on a sensor of this type (i.e., it is unloaded), much of the light from conduit 1120 will be transmitted to and received by pickup optical line 1140. However, if downward pressure is exerted on shutter 1130 (e.g., if the patient has sufficient weight resting above it), the shutter 1130 will move downward, thereby blocking the transmission of light between the two conduits. This particular arrangement would tend to function as an on/off optical switch. Of course, those of ordinary skill in the art will recognize that in some cases it might be preferably to obtain a continuous measurement of the amount light that is passing through the shutter and the instant invention could certainly be adapted to operate with such a sensor.

Those of ordinary skill in the art will recognize that these are only a few examples of the many different optical and electrical switches/sensors that could be used with the instant invention.

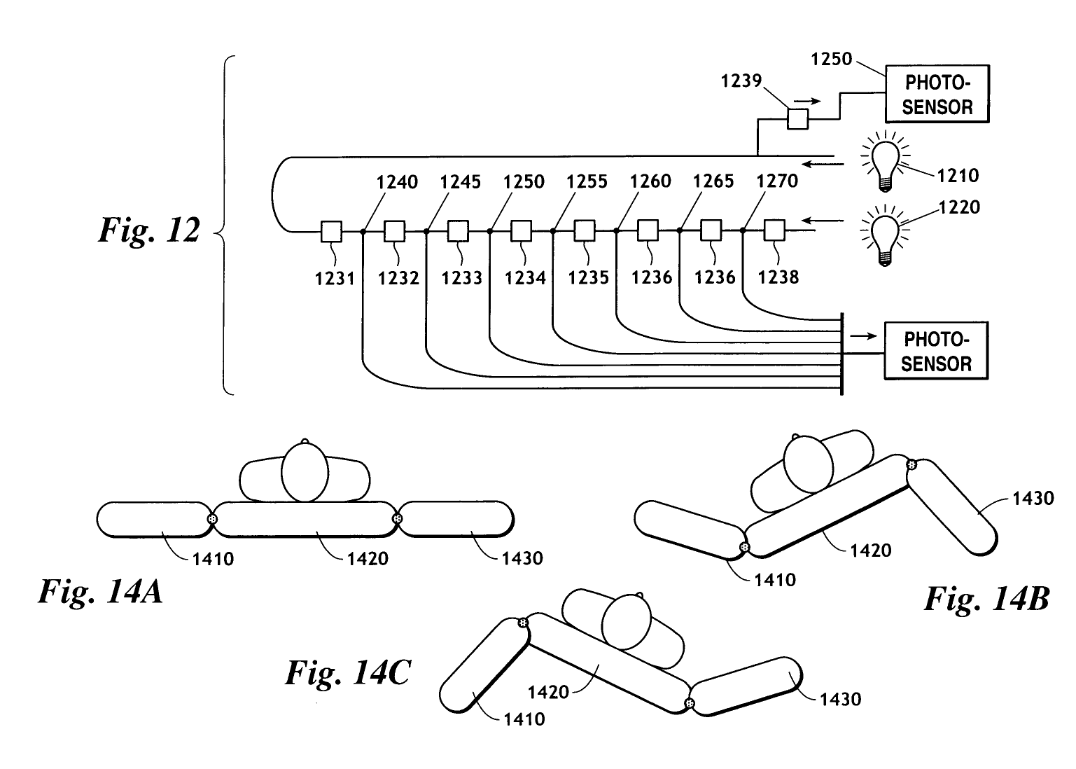

FIG. 12 illustrates a preferred arrangement of the optical sensors 690 within a support strap. Preferably, optical attenuators 1231-1238 would be of the general sort described in FIG. 11, although those of ordinary skill in the art will recognize that other sorts of attenuators could certainly be used. Light pickups 1240-1270 are preferably provided in-line to the main optical conduit 1290 to sample light passing therethrough, after which such light would be transmitted to a junction 1295 and subsequently on to photo sensor 1250. In the preferred arrangement, light junction 1295 would perform a summation of the light arriving from pickups 1240-1270 and pass the total received light intensity on to photo sensor 1250. It is anticipated that each of the light pickups 1240-1270 would be longitudinally spaced apart within a support strap. In a preferred arrangement, light from sources 1210 and 1220 will be alternately fed into conduit 1290. Photo sensor 1250 would have knowledge of which of the two light sources was activated and that information could be used to determine where the patient's weight is resting on a given strap. Finally, note that calibration optical attenuator 1239 has been introduced to allow the array of optical attenuators 1231-1238 to be calibrated.

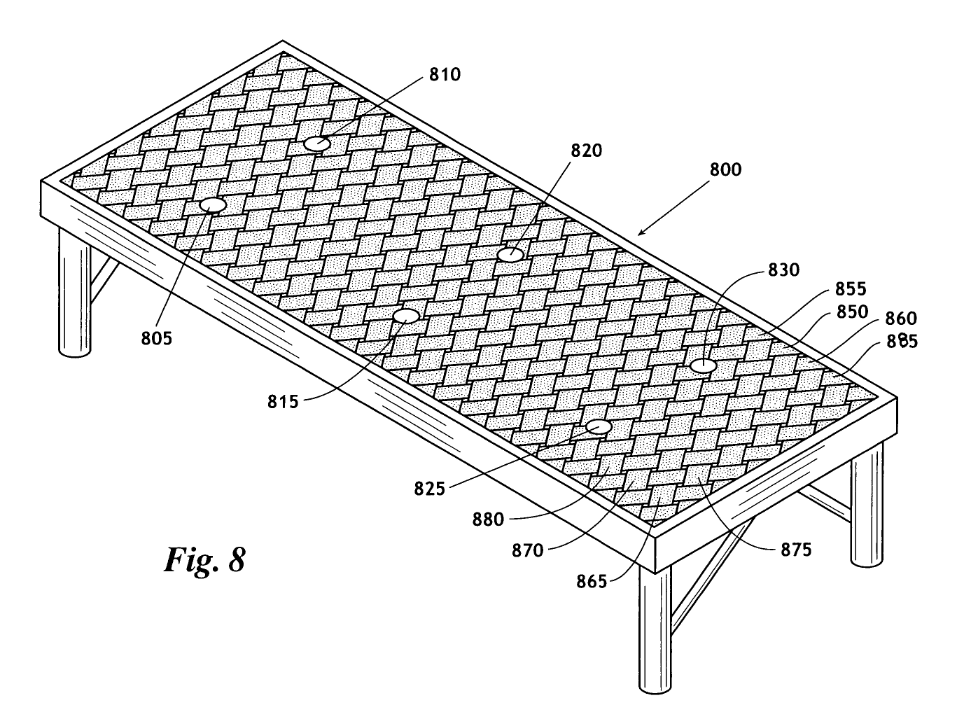

Note that the instant invention would be suitable for use on a chair (whether or wheelchair or stationary chair), of on a bed or other support surface. However, and as generally indicated in FIG. 8, where larger surfaces are involved, it is preferred that the support straps run diagonally rather than parallel with the borders of the bed frame. Of course, similar advantages to the use of diagonal straps could be realized on smaller surfaces as well and both arrangements should be considered preferred alternative embodiments of the instant invention. As might be expected, a network of diagonal straps would be adjusted in a manner similar to that taught in connection with the rectangular configuration of straps in the chair embodiment 110. That being said, and for purposes illustration only, a simple illustration will be provided of a preferred method of redistributing pressure in the embodiment of FIG. 8. Assume that a patient is resting on bed 800 and that there the attached strap sensors have detected six pressure points 805, 810, 815, 820, 825, and 830 which might correspond to a patient's shoulders, hips, and heels, respectively. Then, for example with respect to pressure point 830, it is likely that straps 860 and 865 bear most of the weight. Thus, preferably those straps would be loosened and others in the vicinity would be tightened. For example, straps 850, 885, 870, and 875 would be likely candidates for tightening. Of course, strap 880—which is proximate to the straps that are targeted for tightening—also passes in the vicinity of support point 825 and normally it would be loosened to help relieve pressure on the support point. As a consequence, it may be necessary to make several passes through straps, slightly adjusting the tension in each up or down at each iteration, with the amount and direction of adjustment being controlled by the artificial intelligence of the attached electronic monitor.

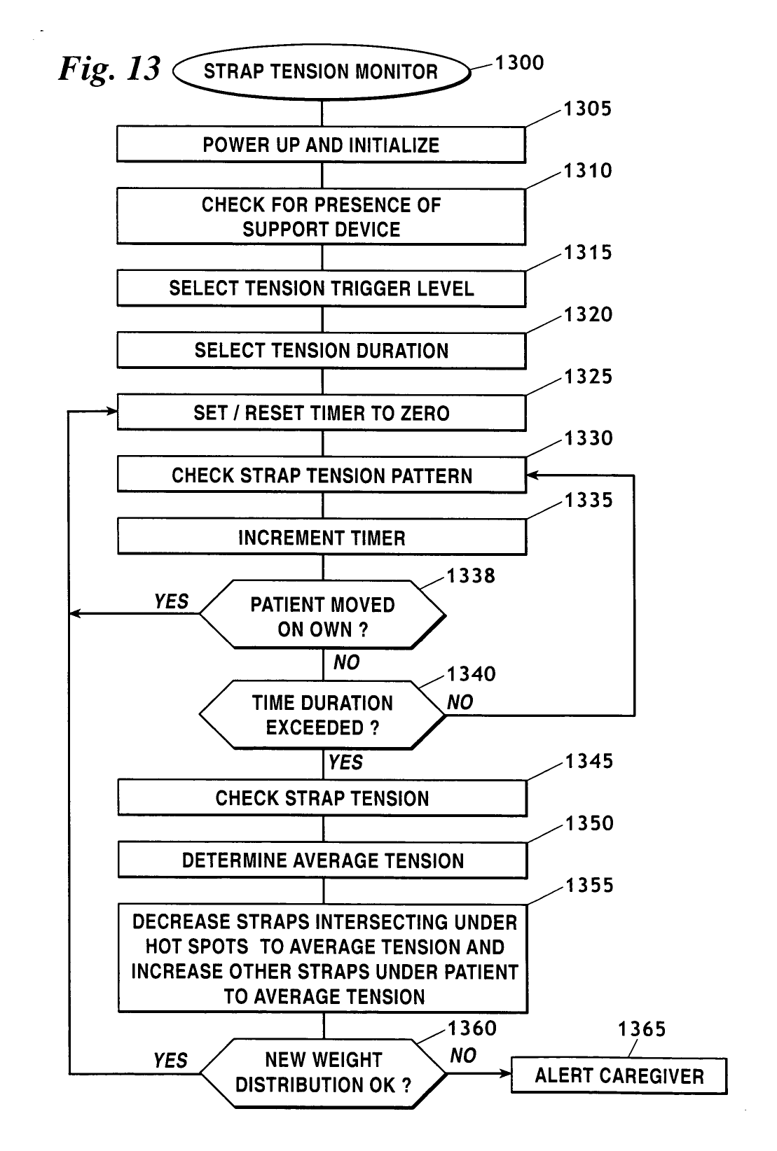

Finally, as is illustrated generally in FIG. 13, the preferred method of adjusting the tension in the straps in order to move weight supporting areas is preferably a feedback mechanism. As an initial step, it is preferred that the attached monitor power up and initialize (step 1305), a part of which initialization could include setting default variable values and clearing memory in anticipation of operation. As a next preferred step 1310, the program will check for the presence of support device 110 or similar device. Obviously, failing to find such device attached, or finding a device that is attached but that is not properly connected or has some internal malfunction, would preferably generate an alarm of some sort to notify the caregiver of that fact.

As a next preferred step 1315, a tension threshold level in the straps will be specified. This might either come by way of input from a user or as a parameter that is chosen to work with the particular variant of support surface 110 which is employed. Those of ordinary skill in the art will recognize that, depending on the materials involved, different tension threshold levels might be set. Note that, for purposes of the instant invention, the tension threshold level could be either a direct measurement of the tension in the strap, or some measure of the weight distribution on the strap. In either case, the same term will be applied.

Next, the instant invention will preferably select a tension duration (step 1320). That is, this tension duration would be the length of time in which a hot spot would be allowed to be maintained until corrective action is taken, i.e., until the tension is adjusted in the support straps. This time period might be as short as few minutes (or even less) or as long as an hour or more depending on the physical needs of the patient and the recommendation of the attending physician. In any case, it is preferred that this time period be on the order of 10 minutes or so, which is a value that is commensurate with the amount of time that oxygenated blood can safely be excluded from a fleshy area without significant risk of necrosis.

Next, the algorithm preferably enters an event monitoring loop (steps 1325-1360) which will preferably operate near-continuously to determine the weight/tension distribution on the straps. As a first step of the preferred monitoring loop, a timer will be set equal to zero (step 1325). Although there are many different timers that might be utilized, this particular timer is intended to measure the length of time that weight has been bearing on a particular spot. As a next preferred step, the monitor will check and, if necessary, calculate the strap tension pattern within the support device 110 (step 1330). This might be done by any method, including those described previously as being preferred for this invention.

The timer will preferably be incremented (step 1335) before checking to see if the patient has relocated himself or herself without assistance (step 1338) during the intervening time period. If so, the timer is preferably reset to zero (step 1325) and the monitoring processing continues. Note that, depending on the application, the timer might not be reset except upon the detection of a significant movement as that term is used herein. As a next preferred step, the timer value is compared with the selected time duration parameter (step 1340). If the duration parameter has not been exceeded, the algorithm will preferably return to step 1330, where the strap tension pattern will once again be evaluated. As was explained previously, the instant algorithm will preferably operate in a near continuous manner. However, it is certainly contemplated that a timed delay or wait loop might be inserted to cause there to be some delay between steps 1340 and 1330.

If the duration parameter has been exceeded, the strap tension pattern will be calculated (step 1345), so that straps which bear weight can be determined.

For those straps that bear weight, according to a first preferred variation an average tension will preferably be calculated (1350). This value might be calculated as a numerical average of the tensions measured on the weight bearing straps, a geometric average, a median, or any other composite measure of the tension or weight bearing on each of the straps. In another preferred variation, the total stress (or, equivalently, weight, pressure, etc.) on all of the straps might be determined and used hereafter.

Although the distribution of weight on the straps might be altered in any number of ways, and those of ordinary skill in the art will be well able to devise such, a presently preferred method of adjusting the weight distribution of the patient is by decreasing the tension in straps that are currently above average tension until those straps are at average tension, and increasing the tension in those straps that bear weight that have a tension less than the average, until those straps are at average bearing weight (step 1355). Said another way, the instant invention seeks to produce a uniform stress or weight distribution in the straps by increasing the tension on those straps that are below average in the amount of weight they bear, and decreasing the amount of weight borne by straps that are above average (i.e., by reducing the tension in those straps). As has been discussed previously, in the preferred arrangement, the attached electronic patient monitor will signal to the relevant tensioner 205-280 that it is to either loosen or tighten the belt connected thereto. It is anticipated that, rather than making large adjustments in the strap tensions, the instant invention will make small incremental adjustments and then stop and re-measure the tension pattern to see if the stress pattern has moved in the desired direction. Assuming that by repeated adjustments of the tension in the various straps that the weigh distribution has been modified to be acceptable, the instant invention continues by resetting the timer to zero and entering its timing loop.

On the other hand, if the adjustments after several iterations do not appear to have relocated the hot spots away from their current position, it is preferred that data related to the current pattern of hot spots (and other operational data) be stored for review by the caregiver or a subsequent analysis program. Additionally, it is preferred that a caregiver be notified (step 1355) so that the patient may be examined and manually relocated if that is necessary.

According to another preferred embodiment, the tension in the straps will be adjusted to remove hot spots by reversing the roles of the support/weight bearing straps and those of the non-weight bearing straps. That is, in this variation as a first step the straps that support the greatest proportion of the patient's weight will be determined. For example, in FIG. 7, assume for purposes of illustration that hot spot 710 is being principally supported by straps 620, 625, 650, and 655 and that this is the only weight bearing point. It will similarly be assumed that this support is reflected in the tension (weight, pressure, etc.) that is measured on those straps. In this preferred embodiment, the tension on straps 615 and 630 would be increased—and the tension on straps 620 and 625 would be decreased—to the point where the straps 615 and 630 support the patient's entire weight. Straps 620 and 625 would preferably be essentially slack or non-weight bearing. Similarly, the weight on straps 650 and 655 would preferably be shifted to adjacent straps 645 and 660. Note, however, that in this scenario the patient does not appear to have significant contact with strap 645 and, thus, likely the tension in the vertical straps 615 and 630 would need to be adjusted accordingly.

Of course, the previous simplistic scenario assumes that there is a single weigh bearing point that needs to be adjusted. In actuality, there will likely be at least two such hot points and conceivably many more. In some cases, it might be necessary to successively relieve each hot point for some period of time in rotation. In other complex cases, the pattern of strap tension adjustments might be solved as an optimization or linear programming problem, wherein the tension on certain straps is to be maximized and others is to be minimized under the general constraint that the patient's entire weight must be supported by all of the straps.

Note that in most cases it won't be necessary to have the non-supporting straps be entirely slack (i.e., completely non-weight bearing) as a certain amount of weight can be supported by soft tissue without cutting off the blood supply thereto. Those of ordinary skill in the art will recognize that some experimentation may be required in order to determine what would be an acceptable level of strap tension for a given patient.

Finally, and as is generally indicated in FIG. 14, according to another preferred embodiment there is provided a method and apparatus of automatically relocating a patient on a support surface to reduce the risk of formation of pressure sores, which monitors the patient's position on the support and surface and only operates mechanically to turn the patient if the patient has not turned himself or herself within the specified time period. In a preferred arrangement, mechanical bed 1400 (seen in FIGS. 14A-14C as viewed from the head of the bed) is hinged in three sections. Left 1410 and right 1430 lateral members are preferably hinged on each side of the central support member 1420 so that they may be automatically folded and extended under control of a computer or similar programmable device, thereby adjusting the relative inclination angles between the lateral members 1410 and 1430 and central member 1420. Preferably, the instant bed 1400 will be initially placed in a flat position by leveling the three lateral members 1410-1430. This would be advantageous, for example, during patient entry into the bed and at any time thereafter when it is necessary for the patient to leave the bed 1400.

During normal operations, it is preferred that a patient location sensor mechanism be utilized to determine at least approximately the patient's position and/or orientation within the bed on a near-continuous basis. Although many such sensors might be utilized, one example of a preferred sensor may be found in U.S. Pat. No. 6,646,556, which has been identified previously. In the preferred arrangement, the sensor will be at least able to provide an approximate “X” and “Y” location of the patient within the bed, thereby making it possible to automatically determine whether and when the patient has last moved. Note when “X” and “Y” locations are referred to herein, that phrase could be referring to a single two-dimensional coordinate (e.g., the location on the support surface of the center of gravity of the patient) or, more generally, it might be used to refer to a collection of coordinates that describe the patient's position, e.g., the coordinates might describe the perimeter (or area) of the contact region between the patient's body with the bed, the coordinates might include a tabulation of the coordinates of suspected or known patient “hot spots”/support regions, etc. Those of ordinary skill in the art will readily be able to devise alternative arrangements.

Further, it is preferable that if a predetermined period of time passes and the patient has maintained the same position during that time (or, more importantly, has not shifted weight away from the pressure points that support his or her weight) that the appropriate lateral member 1410 and 1430 be flexed to cause the patient to shift toward the left (FIG. 14B) or the right (FIG. 14C) side of the bed, thereby transferring the patient's weight to other pressure points and allowing the previously compressed tissues to reoxygenate. Those of ordinary skill in the art will recognize that this flexing of the later members might be accomplished in many ways, but in one preferred arrangement each lateral member 1410-1430 will be raised or lowered using hydraulic cylinders. In another preferred arrangements, inflatable air bladders will be positioned under each later member, with the inflation/deflation thereof being used to raise and lower each member relative to the others. In each case, the raising/lowering of the mechanical element will be under the control of a microprocessor that preferably also has access to patient movement data so that the lateral members can be adjusted only when necessary.

In another preferred embodiment and as is generally indicated in FIG. 17, an automated turn sheet will be used to roll the patient to a new position if that becomes necessary. That is, those of ordinary skill in the art will recognize that a turn sheet 1610 is a device that can be used by the caregiver to assist in moving a patient to a new position in the bed (e.g., see FIG. 16 which illustrates the prior art manual use of a such a sheet). However, the instant invention utilizes risers 1710 or a similar mechanical means to lift one side of the turn sheet 1610 under software control if the patient has not moved during the previous turn interval.

Finally, it should be noted it is preferably that this bed flexure only be implemented if the patient has not moved during the prescribed time period (e.g., two hours). Thus, if the patient has been moving within the bed under his or her own power the instant invention will not intervene and the patient will be allowed to rest uninterrupted. On the other hand, if the patient has not been moving the instant invention will activate, even if such activation means that the patient's rest will be interrupted. Information from the patient location sensor will be used to help make this determination along with input from the caregiver on specific needs and conditions of the patient.

### CONCLUSIONS

A principal goal of the instant invention is to help reduce the risk of pressure sores in a patient through active mechanical intervention only when necessary. That is, in each embodiment disclosed herein it is preferred that the patient's movement history be monitored and, if the patient has moved him or her self during the proper time window, the instant invention will not seek to move him or her again, the goal being that if the patient exhibits sufficient activity that no action will be taken by the mechanism that controls the bed or chair that contains the patient. Ideally, in a case where the patient is sufficiently active no intervention on the part of the instant invention will take place at all. On the other hand, if the patient just need a little bit of support, the instant invention—because its operations are based the patient's activity level—will provide just that bit of support thereby maintaining the optimal physical health while maintaining the patient's dignity and self concept.

Note that if a microprocessor is utilized as a component of the monitor 500, the only requirement that such a component must satisfy is that it must minimally be an active device, i.e., one that is programmable in some sense, that it is capable of recognizing signals from a bed mat or similar patient sensing device, and that it is capable of initiating the sounding of one or more alarm sounds in response thereto. Of course, these sorts of modest requirements may be satisfied by any number of programmable logic devices (“PLD”) including, without limitation, gate arrays, FPGA's (i.e., field programmable gate arrays), CPLD's (i.e., complex PLD's), EPLD's (i.e., erasable PLD's), SPLD's (i.e., simple PLD's), PAL's (programmable array logic), FPLA's (i.e., field programmable logic array), FPLS (i.e., fuse programmable logic sequencers), GAL (i.e., generic array logic), PLA (i.e., programmable logic array), FPAA (i.e., field programmable analog array), PsoC (i.e., programmable system-on-chip), SoC (i.e., system-on-chip), CsoC (i.e., configurable system-on-chip), ASIC (i.e., application specific integrated chip), etc., as those acronyms and their associated devices are known and used in the art. Further, those of ordinary skill in the art will recognize that many of these sorts of devices contain microprocessors integral thereto. Additionally, those of ordinary skill in the art will recognize that discrete electronic components could be assembled to create a circuit that exhibits at least a portion of the operating function of the instant invention. Thus, for purposes of the instant disclosure the terms “processor,” “microprocessor” and “CPU” (i.e., central processing unit) should be interpreted to take the broadest possible meaning herein, and such meaning is intended to include any PLD or other programmable device (to include custom circuitry formed from digital and/or analog components) of the general sort described above.

Additionally, in those embodiments taught herein that utilize a clock or timer or similar timing circuitry, those of ordinary skill in the art will understand that such functionality might be provided through the use of a separate clock circuit or implemented in software within the microprocessor. It might further be obtained with discrete, linear, timers and logic circuitry: a microprocessor is not strictly required, but is merely convenient. Thus, when “clock” or “time circuit” is used herein, it should be used in its broadest sense to include both software and hardware timer implementations.

Further, note that the instant invention may also be utilized to detect when a patient is moving toward the edge of the support surface with the intent of exiting the bed or chair. It should be clear that if none of the strap sensors are registering tension, the patient is no longer present on the support surface and, presumably, will have left the bed or chair into which he or she had been placed. Thus, the instant invention can function in connection with (or in place of) a conventional “exit monitor” and be used to signal the nursing staff when a patient has risen.

Note further that a preferred electronic monitor of the instant invention utilizes a microprocessor with programming instructions stored therein for execution thereby, which programming instructions define the monitor's response to the patient. Although ROM is the preferred apparatus for storing such instructions, static or dynamic RAM, flash RAM, EPROM, PROM, EEPROM, or any similar volatile or nonvolatile computer memory could be used. Further, it is not absolutely essential that the software be permanently resident within the monitor, although that is certainly preferred. It is possible that the operating software could be stored, by way of example, on a floppy disk, a magnetic disk, a magnetic tape, a magneto-optical disk, an optical disk, a CD-ROM, flash RAM card, a ROM card, a DVD disk, or loaded into the monitor over a wired or wireless network as needed. Additionally, those of ordinary skill in the art will recognize that the memory might be either internal to the microprocessor, or external to it, or some combination of the foregoing. Thus, “program memory” as that term is used herein should be interpreted in its broadest sense to include the variations listed above, as well as other variations that are well known to those of ordinary skill in the art.

Additionally, it should be noted that one preferred embodiment of the instant invention monitors the patient for significant changes in position and, only if the patient has moved significantly, is a mechanical relocation of the patient support points avoided. That is, in this embodiment it is preferred that the patient's position be monitored, not just for a any kind of movement, but for a movement that results in a position change that persists for a period of time at least long enough for the previously compressed tissues to reoxygenate. Such a move, i.e., one that is maintained at least long enough for there to be sufficient reoxygenation of the previously compressed tissues, is referred to herein as a significant movement. In the preferred embodiment, the patient will be monitored and, only if a significant movement occurs during the turn interval, the patient will not be mechanically repositioned. However, if the patient has moved during the monitored period, and such move was not significant, the patient will be mechanically relocated as has been described previously.

Still further, although the preferred embodiment of the apparatus utilizes a lattice of orthogonally oriented flat straps to support the patient, that configuration is only one of many that could be devised by those of ordinary skill in the art. For example, although the supporting straps preferably cross each other in an orthogonal arrangement, the instant invention would operate similarly if the supporting straps intersect at some angle other than about 90°. Additionally, although in the preferred embodiment the rigid frame 300 upon which the straps are mounted is preferably rectangular, that shape is not required and should be considered to be a design choice that can be freely modified depending on the needs of the patient (e.g., it might be pentagonal, octagonal, elliptical, or even round in some circumstances). Further, although the term “strap” has been used herein to describe the active support members that are used in the preferred embodiments, those of ordinary skill in the art will recognize that other sorts of arrangements are possible. For example, three sets of straps that intersect at 60° angles could be used instead of orthogonal strap pairs.

In another preferred embodiment (FIG. 18), instead of nylon straps, flat inflatable tubes 1810 (e.g., rubber or elastic tubing) will be used instead of straps to vary the patient's weight distribution. In such an embodiment, rather than stretching each tube to change its weight bearing status each will instead be inflated or deflated to change the relative tension therein. In a preferred variation, periodically the air will be completely evacuated from each of the support tubes (e.g., via sensor and/or hydraulic lines 1820), followed by an injection of a fixed volume into the tubes. By thereafter measuring the air pressure in each tube, an estimate may be formed of the location of patient hotspots, with support regions of the body tending to cause a higher air pressure (PSI) within the tube on which the patient is resting. This approach would have the additional advantage of periodically massaging the support region when the air was withdrawn/replaced. Similarly, when adjacent tubes are inflated an immediate feedback of the reduction in pressure on non-inflated will be available by measuring the corresponding reduction in PSI. Note that in this embodiment, it would be preferably to have the tubes supported from beneath by a flat surface, as the tubes 1810 might prove to be too elastic to support the patient properly.

In still another preferred embodiment and as is generally indicated in FIG. 19, a matrix 1900 of preferably separately adjustable support surfaces 1910 will be utilized. In this embodiment, the height of each support element of the matrix will preferably be individually adjustable so that it can be raised or lowered under computer control. As should be clear, this embodiment would operate directly to modify the patient's weight distribution. In one preferred arrangement, the support elements will be raised or lowered through the use of air hydraulic cylinders or, alternatively, worm drives, cams, etc., all under computer control. In the event that hydraulics are used, an estimate of the pressure on each element could be obtained by measuring the air pressure in the corresponding cylinder. In another arrangement, a longitudinal cam will operate to raise or lower each column of support surfaces.

However, whatever sort of active support member is utilized it must, at minimum, be substantially flat (or, for example, have a flat surface surmounted with a compressible or other padded surface) on its upper face so as to provide a comfortable resting place for the occupant. Further, it must have the tensile strength to withstand being subjected to tension for purposes of supporting the patient's weight at different points. Thus, when the term “strap’ is used herein that term should be broadly construed to include traditional nylon webbing as well as other structure (e.g., silk, leather, thin sheet metal, cotton, and rayon or any other relatively inelastic material) that satisfies the requirements set out above. Further, and according to one preferred embodiment, the strap could be comprised of inflatable tubes.

Additionally, although in the preferred embodiment the frame 300 upon which the straps are stretched is substantially planar, it should be clear that this configuration is only preferred and is not required. In some preferred embodiments, the frame will be curved to better accommodate the patient's body shape. In other preferred embodiment, a shaped foam support will be created that at least roughly matches the contours of the patient's body. The foam will then be subdivided into a matrix of (preferably) separately movable elements that can be raised and lowered under computer control in a manner similar to that disclosed in FIG. 19 (discussed previously). This would have the advantage of creating a support surface that can accommodate irregular anatomies.

Further, those of ordinary skill in the art will recognize that it is not essential to the operation of the instant invention that the tension on every supporting strap be determinable. There could certainly be static straps, or straps that are adjustable in tension according to the tension in a neighboring belt (i.e., without being individually measured for tension). That being said, in the preferred embodiment the tension on each strap will be separately measurable and the tension in each belt will be separately adjustable according to the measured tension. In another preferred arrangement, only one set of straps will be monitored for tension although both sets would be adjustable. In this case, tension would be applied to both sets of straps but the results would only be measured on one set. Although this would be less than ideal, those of ordinary skill in the art will recognize how by trial and error the patient's hot spots could be sensed and the tension varied in a manner analogous to that described previously. Of course, one obvious advantage of this approach is that the cost of manufacturing the device would be substantially reduced.

Still further, tension is a preferred and natural way to measure that portion of the patient's weight that is born by each of the straps. However, those of ordinary skill in the art will recognize that there may alternatives measurements that might be utilized instead. For example, it might be preferable in some embodiments to directly measure the weight of the patient above a sensor point. In other embodiments, the weight that is supported by each strap might be determined via optical sensors of the sort taught in U.S. Pat. No. 6,646,556 noted previously. In still other variations, the air pressure within an inflatable support tube would be measured as has been described previously. In fact, in some embodiments closure time—rather than weight or tension—will be used to calculate a function representative of the patient's weight. That is, if the switches 690 are simple pressure activated (i.e., “on”/“off”) switches, even that information could be used to help reduce the risk of development of pressure sores by, for example, tracking the length of time that each switched is closed and noting the pattern of switch closures. Then, rather than loosening or tightening the straps based on tension/weight, the same sorts of adjustments could be made based on the pattern of switches that have been closed in excess of a predetermined period of time. Of course, by varying the tension on the straps an amount sufficient to “open” a “closed” switch or “close” an “open” one could potentially be quite beneficial to the patient. Thus, when the instant disclosure refers to a value that is “representative of the patient's weight” on a strap, that phrase should be broadly construed to include both direct measurements of strap tension as well as any other sort of measurement that directly or indirectly permits even an approximate determination of patient support hotspots.

Additionally, those of ordinary skill in the art will recognize that the use of the term “hinge” herein should not be limited to conventional jointed hinges (e.g., piano-type continuous hinges, gate hinges, furniture hinges, etc.), but instead should be understood to include any sort of flexible connection between the left 1410, right 1430 and lateral 1420 members that allows their relative orientations to be varied. Note that, in some preferred embodiments, the left 1410, right 1430 and lateral 1420 members will be closely adjacent to, but unconnected with, each other and the flexibility of the bedding or mattress itself will provide the “hinge” as the three members are tilted with respect to each other.

Finally, it should be noted that the term “nurse call” as that term has been used herein should be interpreted to mean, not only traditional wire-based nurse call units, but also any system for notifying a remote caregiver of the state of a patient, whether that system is wire-based or wireless (e.g., R.F., ultrasonic, IR link, etc.). Additionally, it should be clear to those of ordinary skill in the art that it may or may not be a “nurse” that monitors a patient remotely and, as such, the term “nurse” should be broadly interpreted to include any sort of caregiver, including, for example, untrained family members and friends that might be signaled by such a system.

Thus, it is apparent that there has been provided, in accordance with the invention, a patient sensor and method of operation of the sensor that fully satisfies the objects, aims and advantages set forth above. While the invention has been described in conjunction with specific embodiments thereof, it is evident that many alternatives, modifications and variations will be apparent to those skilled in the art and in light of the foregoing description. Accordingly, it is intended to embrace all such alternatives, modifications and variations as fall within the spirit of the appended claims.

1. A method of reducing the risk of development of pressure sores in a patient, wherein is provided a mechanical system for automatically adjusting the patient's position in a bed or chair, comprising the steps of:
(a) specifying a turn interval
(b) initializing a timer, thereby starting the measurement of elapsed time;
(c) determining an initial patient position;
(d) determining a then-current measurement of elapsed time;
(e) determining a then-current patient position,
(f) performing steps (d) and (e) until the first to happen of
(f1) the patient changes position from said initial position, or
(f2) said then-current elapsed time is greater than said turn interval;
(g) if the patient has changed position and said then-current elapsed time is less than said turn interval,
(g1) reinitializing said timer, thereby starting again the measurement of elapsed time, and
(g2) continuing to perform steps (d) through (f) as needed to reduce the risk of pressure sores in the patient; and,
(h) if the patient has not changed position and said then-current elapsed time is greater than said turn interval, mechanically adjusting the patient's position to a position different from said initial patient position using said mechanical system, thereby reducing the risk of development of pressure sores in the patient,

2. A method according to claim 1, wherein step (g) comprises the steps of
(i) if the patient has changed position and said then-current elapsed time is less than said turn interval,
(ii) reinitializing said timer only if said change in position is a significant change in position, and
(iii) continuing to perform steps (d) through (f) as needed to reduce the risk of pressure sores in the patient.

3. A method according to claim 1, wherein said mechanical system comprises:
(1) a support surface frame, said frame having a rigid periphery and an interior;
(2) a network of interleaved straps suspended from said frame periphery,
(2a) said straps being at least for supporting the patient's weight thereon, and,
(2b) each of said straps having a first terminus and a second terminus;
(3) at least one tensioning device in mechanical communication with both of said first and said second strap ends, said tensioning device for adjusting a tension in various ones of said straps;
(4) a microprocessor in electronic communication with said at least one tensioning devices and controlling an amount of tension in each of said straps thereby, said microprocessor being programmed to respond to a plurality of computer instructions comprising:
(4a) identifying at least one pressure point on the patient's body that is in contact with at least one of said support straps,
(4b) identifying one or more straps proximate to each of said at least one pressure points, thereby identifying at least one support strap,
(4c) determining a value representative of a tension in each of said support straps,
(4d) identifying at least one strap different from said support straps, thereby identifying at least one non-support strap,
(4e) determining a value representative of a tension in said at least one of said non-support straps, and,
(4f) transmitting a signal to at least one of said at least one tensioning devices, said signal at least containing instructions for increasing said tension in at least one of said non-support straps and decreasing said tension in at least one of said support straps, thereby relocating at least one of said patient pressure points to a different location on the patient's body.

4. An apparatus for reducing the risk of development of pressure sores in a patient at rest on a support surface, comprising:
(a) a support surface frame, said frame having a rigid periphery and an interior;
(b) a network of straps suspended from said frame periphery,
(b1) said straps being for supporting at least a portion of the patient's weight thereon, and,
(b2) each of said straps having a first terminus and a second terminus;
(c) at least one tensioning device in mechanical communication with each of said first and said second strap ends, said tensioning device for adjusting a tension in various ones of said straps;
(d) a microprocessor in electronic communication with said at least one tensioning devices and controlling an amount of tension in each of said straps thereby, said microprocessor being programmed to respond to a plurality of computer instructions comprising:
(d1) identifying at least one pressure point on the patient's body that is in contact with at least one of said support straps,
(d2) identifying one or more straps proximate to each of said at least one pressure points, thereby identifying at least one support strap,
(d3) determining a value representative of a tension in each of said support straps,
(d4) identifying at least one strap different from said support straps, thereby identifying at least one non-support strap,
(d5) determining a value representative of a tension in said at least one of said non-support straps, and,
(d6) transmitting a signal to at least one of said at least one tensioning devices, said signal at least containing instructions for increasing said tension in at least one of said non-support straps and decreasing said tension in at least one of said support straps, thereby redistributing the point of pressure to a different location on the patient's body.

5. An apparatus for reducing the risk of development of pressure sores in a patient according to claim 4, wherein step (d1) comprises the steps of:
(i) selecting at least one support strap,
(ii) measuring a tension in each of said selected at least one support straps, and,
(iii) identifying from at least said measured tensions at least one pressure point on the patient's body that is in contact with said selected at least one support straps.

6. An apparatus for reducing the risk of development of pressure sores in a patient according to claim 4, wherein said frame comprises a pan.

7. An apparatus for reducing the risk of development of pressure sores in a patient according to claim 4, wherein said frame comprises a substantially rectangular member with an aperture therethrough.

8. An apparatus for reducing the risk of development of pressure sores in a patient according to claim 4, wherein said frame is substantially planar.

9. An apparatus for reducing the risk of development of pressure sores in a patient according to claim 4, wherein said network of straps comprises a first plurality of straps and a second plurality of straps, wherein said first and second plurality of straps are substantially transverse to each other and wherein said first and second plurality of straps are interleaved.

10. An apparatus for reducing the risk of development of pressure sores in a patient according to claim 4, wherein said straps are selected from a group consisting of nylon, silk, leather, thin sheet metal, cotton, rubber tubing, and rayon.

11. An apparatus for reducing the risk of development of pressure sores in a patient according to claim 4, wherein said frame is substantially rectangular.

12. An apparatus for reducing the risk of development of pressure sores in a patient according to claim 4, wherein said at least one tensioning device comprises as many separate tensioning devices as there are straps, each of said separate tensioning devices being attached to one of said straps at said strap first strap end and at said strap second strap end.

13. An apparatus for reducing the risk of development of pressure sores in a patient according to claim 12, wherein each of said separate tensioning devices is a worm gear drive.

14. A method for reducing the risk of development of pressure sores in a patient at rest on a support surface,
wherein is provided a support surface comprised of an interleaved network of supporting straps suspended from a generally rigid frame,
wherein a value representative of the weight being born by each of supporting said straps may be automatically determined, and,
wherein a tension in said plurality of straps may be automatically varied, comprising the steps of:
(a) selecting at least two of said straps;
(b) for each of said selected straps, measuring at least one value representative of a proportion of the patient's weight being supported thereby;
(c) using at least two of said measured values to identify at least one pressure point on the patient's body that is in contact with said straps;
(d) identifying one or more straps proximate to each of said at least one pressure points, thereby identifying at least one support strap;
(e) determining a value representative of a tension in each of said support straps;
(f) identifying at least one strap different from said support straps, thereby identifying at least one non-support strap;
(g) determining a value representative of a tension in each of said non-support straps, and,
(h) transmitting a signal to at least one of said at least one tensioning devices, said signal at least containing instructions for increasing said tension in at least one of said non-support straps and decreasing said tension in at least one of said support straps, thereby moving at least one of said pressure points to a different location on the patient's body and reducing the patient's risk of developing pressure sores.

15. A method according to claim 14, wherein step (h) comprises the steps of:
(h1) determining a value representative of an average tension in all of said support and non-support straps,
(h2) transmitting a signal to at least one of said at least one tensioning devices, said signal at least containing instructions for increasing said tension in at least one of said non-support straps above said average tension and decreasing said tension in at least one of said support straps below said average tension, thereby moving at least one of said pressure points to a different location on the patient's body and reducing the patient's risk of developing pressure sores.

16. A bed for reducing the risk of development of pressure sores in a patient at rest thereon, comprising:
(a) a hinged support surface, said support surface being sized to accommodate a patient lying thereon, said support surface having at least two longitudinal hinges therein, said hinges dividing said support surface into at least three planar support members, each of said support members being movable under control of a microprocessor with respect to an adjacent member along one of said longitudinal hinges to adjust an inclination angle therebetween;
(b) at least one sensor for detecting at least approximately the location of the patient on the support surface;
(c) a microprocessor in electronic communication with said at least one sensor, said microprocessor at least for executing computer code that implements the following instructions:
(c1) selecting a patient turn interval;
(c2) selecting a patient persistence time interval greater than or equal to zero;
(c3) determining an initial patient location;
(c4) at some point later in time after said initial patient location is determined, determining a then-current patient location;
(c5) comparing said then-current patient location with said initial patient location;
(c6) determining an approximate amount of time between said determination of said initial patient location and said determination of said then-current patient location, thereby determining an elapsed time;
(c7) if said then-current patient location is different from said initial patient location, and if said elapsed time is less than said patient turn interval, determining a new initial patient location for use thereafter;
(c8) if said then-current patient location is approximately the same as said initial patient location, and if said elapsed time is less than said patient turn interval, continuing to monitor the patient by performing at least steps (c4) through (c6);
(c9) if said then-current patient location is approximately the same as said initial patient location, and if said elapsed time is greater than or equal to said patient turn interval,
(i) using one or more values representative of said then-current patient location to determine one or more of said support members on which the patient is located,
(ii) selecting at least one of said longitudinal hinges adjacent to at least one of said support members on which the patient is located, and,
(iii) flexing each of said selected longitudinal hinges, thereby moving the patient to a new location.

17. A bed for reducing the risk of development of pressure sores in a patient at rest thereon according to claim 15, wherein the step of flexing each of said selected longitudinal hinges, comprises the step of raising at least one of said support members on which the patient is located.

18. An apparatus for reducing the risk of development of pressure sores in a patient at rest thereon, comprising:
(a) a frame commensurate in size to the patient;
(b) a plurality of separately adjustable support elements mounted on said frame, each of said support elements having at least one sensor associated therewith, said sensors being at least for determining a value representative of a weight of the patient thereon and for sending a signal representative of said value;
(c) a lifting mechanism in mechanical communication with each of said support elements and,
(e) a microprocessor in electronic communication with said sensors and said lifting elements, said microprocessor at least for raising and lowering said support elements in response to said sensor element signals in order to for reduce the risk of development of pressure sores in the patient

19. An apparatus for reducing the risk of development of pressures sores in a patient according to claim 18, wherein said apparatus is a bed.

20. An apparatus for reducing the risk of development of pressure sores in a patient according to claim 18, wherein said apparatus is a chair.

21. An apparatus for reducing the risk of development of pressure sores in a patient according to claim 18, further comprising
(f) digital storage accessible by said microprocessor, said digital storage containing a plurality of computer instructions executable by said computer, said computer instructions comprising:
(f1) reading a patient turn interval;
(f2) reading at least a portion of said sensor signals;
(f3) determining an initial weight distribution of said patient based at least on said sensor signals;
(f4) monitoring said sensors for a time at least as long as said turn interval, wherein during said monitoring time a then-current weight distribution of the patient is repeatedly determined;
(f5) if during said monitoring time any of said then-current weight distributions changes, continuing to monitor said patient for at least one more length of time at least as long as said turn interval;
(f6) if at the end of said monitoring time the weight distribution has not changed, activating a plurality of said lifting mechanisms, thereby adjusting the height of at least two of said support elements, thereby reducing the risk of pressure sores in the patient.
